(19) United States
(12) Patent Application Publication
(10) Pub. No.: US 2026/0329888 A1
(43) Pub. Date: Oct. 22, 2026

(54) DATA ANALYSIS SYSTEM, DATA ANALYSIS APPARATUS AND DATA ANALYSIS METHOD

(71) Applicant: TWAI Inc., George Town (KY)

(72) Inventor: CHE-MIN CHUNG, Kaohsiung City (TW)

(73) Assignee: TWAI Inc., Grand Cayman (KY)

(21) Appl. No.: 19/396,337

(22) Filed: Nov. 21, 2025

Related U.S. Application Data
(60) Provisional application No. 63/790,714, filed on Apr. 18, 2025.
(60) Provisional application No. 63/790,717, filed on Apr. 18, 2025.
(60) Provisional application No. 63/790,718, filed on Apr. 18, 2025.

(51) Int. Cl. G06F 16/26; G06V 30/412

(52) U.S. Cl. CPC G06F 16/26; G06V 30/412

(57) ABSTRACT

The present disclosure provides a data analysis system, a data analysis apparatus, and a data analysis method. The data analysis system includes a user interface, a document parsing module, an artificial intelligence (AI) data analysis module, and a chart generation module. The user interface allows users to input text and upload documents. The document parsing module is configured to extract data from the uploaded documents. The AI data analysis module generates analysis results based on the text input by the user, analyzes multiple data entries extracted from the documents, and stores sorted data in a storage unit. Finally, the chart generation module generates charts based on the analysis results and the sorted data to visually present the analysis results.

### CROSS-REFERENCE TO RELATED APPLICATION

This application claims priorities to and the benefits of U.S. Provisional Patent Application Ser. No. 63/790,714, U.S. Provisional Patent Application Ser. No. 63/790,717 and U.S. Provisional Patent Application Ser. No. 63/790,718, filed on Apr. 18, 2025, the entireties of which are incorporated by reference herein.

### FIELD

The present disclosure relates to a data analysis technology. More particularly, the present disclosure relates to a data analysis system, a data analysis apparatus, and a data analysis method utilizing artificial intelligence (AI) through dialogue and document parsing.

### BACKGROUND

Current data analysis has become an essential tool for decision support and problem-solving across various industries. With the rapid growth of data volume, traditional analysis methods are gradually evolving toward automation and intelligence. Past data analysis relied heavily on statistical models and predefined rule-based systems. Analysts were required to perform data cleaning, structuring, and feature extraction before utilizing algorithms for modeling and inference. While this approach provides a certain level of depth, the process is cumbersome and highly dependent on the experience and technical skills of professional personnel. Particularly when dealing with unstructured data (such as text, voice, or images), it is typically challenging for conventional systems to automatically capture latent semantics and contextual relationships, leading to analysis results limited to a superficial level and an inability to flexibly address complex practical problems.

With the emergence of machine learning and deep learning technologies, the degree of automation in data analysis has significantly improved. In particular, advances in Natural Language Processing (NLP) technology enable systems to understand and generate natural language descriptions to assist in report writing and result presentation. However, such systems typically adopt a closed task-oriented architecture, requiring users to input queries in specific formats before the system can provide answers based on established models. This leads to a lack of flexibility in human-machine interaction and difficulty in conducting open discussions or multi-turn reasoning. Even with the subsequent emergence of conversational chatbots, most are based on pre-trained response templates or task-oriented dialogue models, failing to dynamically generate deeper insights based on actual data. Consequently, the analysis process remains biased toward unidirectional output and lacks true collaborative exploration.

Traditional data analysis systems are overly structured and lack a flexible human-machine collaboration mechanism. Meanwhile, current applications of generative models mostly remain at the level of linguistic assistance and fail to deeply integrate with the data analysis workflow.

### SUMMARY

One objective of a preferred embodiment of the present disclosure is to provide a data analysis system, a data analysis apparatus, and a data analysis method, which utilize a model specifically trained for data analysis, a module configured to convert documents to text, and a visual chart generation module configured to enable visualization of data analysis, thereby allowing users to perform problem-solving driven by free-form dialogue.

In view of the above, a preferred embodiment of the present disclosure provides a data analysis system. The data analysis system includes a user interface, a document parsing module, an artificial intelligence (AI) data analysis module, and a chart generation module. The user interface is configured to input at least one text and upload at least one file. The document parsing module is coupled to the user interface and configured to receive the at least one file and extract a plurality of data entries from the at least one file. The AI data analysis module is coupled to the user interface and the document parsing module, and is configured to: receive the at least one text from the user interface; generate a first analysis result based on the at least one text; receive the plurality of data entries from the document parsing module; analyze and sort the plurality of data entries to generate a plurality of sorted data; and store the plurality of sorted data in a storage unit. The chart generation module is coupled to the AI data analysis module and the storage unit and is configured to: receive the first analysis result from the AI data analysis module; receive the plurality of sorted data from the storage unit; and generate a first chart based on the first analysis result and the plurality of sorted data.

Another preferred embodiment of the present disclosure provides a data analysis method. The data analysis method includes: providing a user interface configured to input at least one text and upload at least one file; extracting a plurality of data entries from the at least one file; providing an AI data analysis module configured to: receive the at least one text from the user interface; generate a first analysis result based on the at least one text; receive the plurality of data entries; analyze and sort the plurality of data entries to generate a plurality of sorted data; receive the first analysis result from the AI data analysis module and the plurality of sorted data from a storage unit; and generate a first chart based on the first analysis result and the plurality of sorted data.

In summary, the preferred embodiments of the present disclosure employ a data analysis system integrating a user interface, a document parsing module, an AI data analysis module, a chart generation module, and a document generation module. The data analysis system can complete the entire workflow from data input and intelligent analysis to chart and document output with high efficiency and accuracy. The data analysis system of the present preferred embodiment first allows a user to input text commands and upload a file via the user interface. The document parsing module automatically extracts multiple data entries from the file, reducing manual processing time and errors. Subsequently, the AI data analysis module performs intelligent analysis and sorting based on the input text and parsed data, generating preliminary analysis results and diverse analysis options. Users can make interactive selections based on their needs to obtain more precise analysis results. Simultaneously, the data analysis system can automatically determine suitable data analysis types, providing preliminary analysis opinions and multiple chart or document generation options, making the data visualization process more flexible and professional. The chart generation module can automatically generate a corresponding chart based on the analysis results and facilitate rapid reproduction through chart code. The document generation module can automatically produce documents in specific formats containing charts and analysis reports based on selections, enhancing report production efficiency and consistency.

To make the objectives, features, and advantages of the present disclosure more comprehensible, preferred embodiments are described in detail below with reference to the accompanying drawings.

### BRIEF DESCRIPTION OF THE DRAWINGS

FIG. 1 is a system block diagram of a data analysis system according to a preferred embodiment of the present disclosure.

FIG. 2 is a schematic diagram of a user interface of the data analysis system according to a preferred embodiment of the present disclosure.

FIG. 3 is a flowchart illustrating the operation of the data analysis system based on an unstructured file uploaded by a user according to a preferred embodiment of the present disclosure.

FIG. 4 is a flowchart illustrating the operation of the data analysis system automatically generating a database based on user requirements and file metadata and performing Extract-Transform-Load (ETL) operation according to a preferred embodiment of the present disclosure.

FIG. 5 is a flowchart illustrating the operation of the data analysis system combining metadata summaries and Retrieval-Augmented Generation (RAG) technology to automatically generate, execute, and analyze database language queries based on user requirements according to a preferred embodiment of the present disclosure.

FIG. 6 is a flowchart illustrating the operation of the data analysis system automatically generating a front-end user interface (UI) based on user requirements according to a preferred embodiment of the present disclosure.

FIG. 7 is a flowchart illustrating the operation of the data analysis system automatically organizing, transforming, and generating a final report based on insights and charts generated during user interaction according to a preferred embodiment of the present disclosure.

FIG. 8 is a detailed system block diagram of a data analysis system according to a preferred embodiment of the present disclosure.

FIG. 9 is a flowchart of the data analysis method according to a preferred embodiment of the present disclosure.

FIG. 10 is a flowchart of sub-steps of step S905 and step S903 of the data analysis method according to a preferred embodiment of the present disclosure.

FIG. 11 is a flowchart of sub-steps of step S905 of the data analysis method according to a preferred embodiment of the present disclosure.

FIG. 12 is a flowchart of sub-steps between step S907 and step S903 of the data analysis method according to a preferred embodiment of the present disclosure.

FIG. 13 is a flowchart of sub-steps of step S905 of the data analysis method according to a preferred embodiment of the present disclosure.

### DETAILED DESCRIPTION

Exemplary embodiments of the present disclosure will be illustrated in the accompanying drawings. Wherever possible, the same reference numerals are used in the drawings and the description to refer to the same or similar parts. Furthermore, the exemplary embodiments are merely one way to implement the design concepts of the present disclosure, and the following embodiments are not intended to limit the scope of the present disclosure.

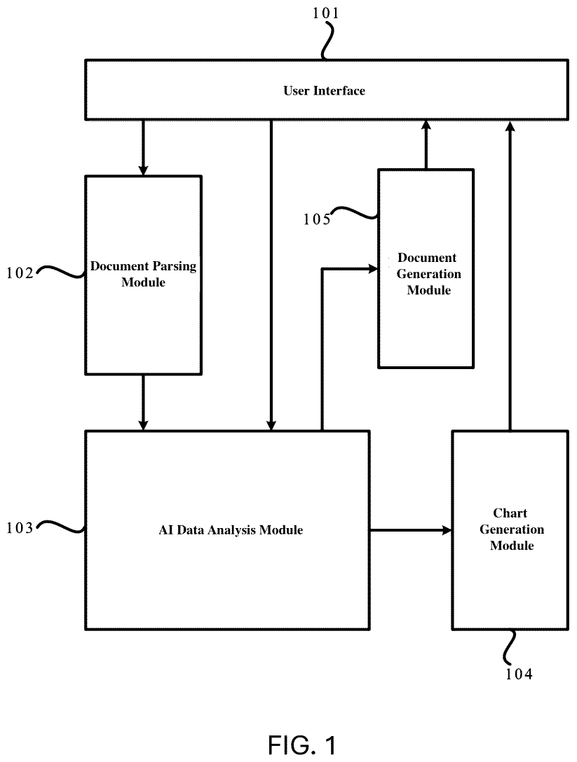

FIG. 1 is a system block diagram of a data analysis system according to a preferred embodiment of the present disclosure. Referring to FIG. 1, the data analysis system includes a user interface 101 for text dialogue and file uploading, a document parsing module 102, an AI data analysis module 103, a chart generation module 104, and a document generation module 105. In one embodiment, the data analysis system may be implemented by a data analysis apparatus having communication and computing capabilities. The data analysis apparatus includes a processor and a storage unit, and the processor is electrically connected to the storage unit. In addition, the aforementioned modules/interface 101~105 may be packaged into multiple computer-executable instructions and stored in the storage unit. The processor may execute the computer-executable instructions to perform the functions or the data analysis method implemented by the modules/interface 101~105. In one embodiment, the storage unit may be, for example, a hard disk, an optical disc, a Universal Serial Bus (USB) flash drive, a Solid State Drive (SSD), etc., but is not limited thereto.

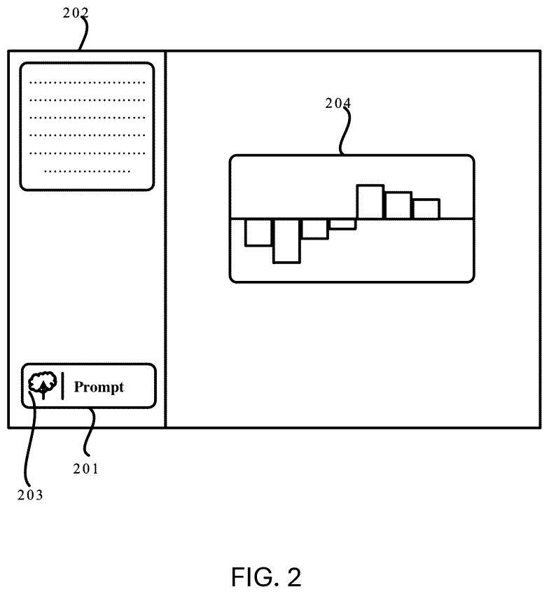

The user interface 101 is a user interface configured to input plain text and upload files. FIG. 2 is a schematic diagram of a user interface of the data analysis system according to a preferred embodiment of the present disclosure. The user interface 101 includes a dialogue input area 201, a dialogue history area 202, a file upload control icon 203, and a chart result display area 204. In the present embodiment, a user may conduct a dialogue with the AI data analysis module 103 by inputting plain text in the dialogue input area 201, and the dialogue will be displayed in the dialogue history area 202. Similarly, the user may click the file upload control icon 203 to upload a file. In one embodiment, the data analysis apparatus further includes a display electrically connected to the processor and configured to display the user interface 101.

The document parsing module 102 is coupled to the user interface 101 and is configured to receive the file uploaded through the user interface 101 and parse it into a text-based document. A general language AI model typically only receives plain text. To allow the AI data analysis module 103 of the preferred embodiment of the present disclosure to receive information of the document, the document parsing module 102 is additionally provided and is configured, for example, to parse binary formats (such as .doc, .xls, pptx) or extensible markup language (XML) (such as .docx, .xlsx, .pptx), or utilize Optical Character Recognition (OCR) to read files such as PDF files. Once these files are parsed, they are converted into a plain text format to facilitate the AI data analysis module 103 in identifying the text or converting tables within the files into database formats, such as SQL or JSON, making the data easier for the AI data analysis module 103 to recognize.

The AI data analysis module 103 is coupled to the user interface 101 and the document parsing module 102. The AI data analysis module 103 mainly reads plain text dialogues and instruction prompt (Prompts) input by the user in the user interface 101 to respond thereto. Furthermore, if a user uploads a file via the user interface 101, the file is first parsed by the document parsing module 102 and then provided to the AI data analysis module 103 in a plain text format. After the AI data analysis module 103 identifies the plurality of data entries received, it performs analysis and sorting to generate a plurality of sorted data and responds accordingly. For subsequent use, the sorted data is stored in a storage unit.

Moreover, the AI data analysis module 103 is trained using a four-stage logic: Plan, Do, Check, and Act (PDCA). It can automatically plan analysis steps and methods (Plan) upon receiving data, execute data processing and intelligent computation (Do), then compare and verify based on the analysis results (Check), and continuously correct and optimize the analysis model based on the verification results (Act), enabling the overall analysis process to possess self-correction capabilities.

The chart generation module 104 is coupled to the AI data analysis module 103 and is configured to generate a chart based on the output of the AI data analysis module 103. The document generation module 105 is coupled to the AI data analysis module 103 and is configured to generate a specific format document based on the output of the AI data analysis module 103, such as a database document in SQL or JSON, a Word document, an Excel spreadsheet, or a PDF document.

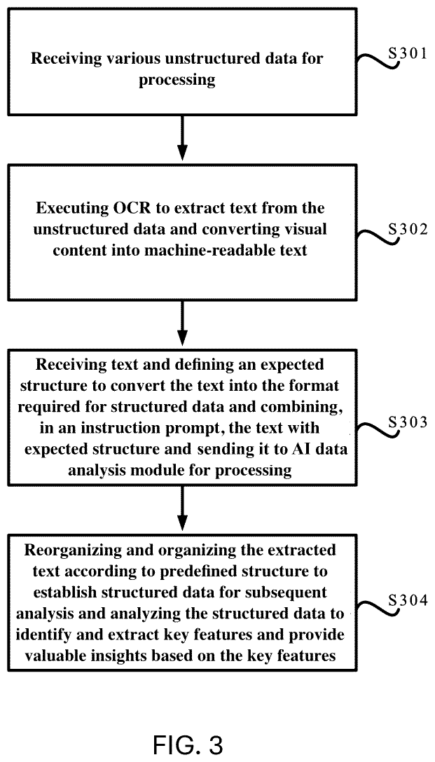

FIG. 3 is a flowchart illustrating the operation of the data analysis system based on an unstructured file uploaded by a user according to a preferred embodiment of the present disclosure. Referring to FIG. 3, the steps for the data analysis system to operate based on the unstructured file uploaded by the user include:

Step S301: Processing an unstructured file. First, the user interface 101 receives an unstructured file (e.g., image, PDF, scanned file, etc.) uploaded by the user and initiates the processing workflow. The original file is sent to the document parsing module 102 for parsing to obtain a required output format (e.g., a desired JSON schema or report template).

Step S302: Executing Optical Character Recognition (OCR) to extract text from the unstructured data and converting visual content into machine-readable text. The document parsing module 102 performs OCR on an image or a scanned PDF, performs layout analysis (e.g., fields, tables, title positions), and returns machine-readable text segments and location information (e.g., paragraphs, table cells, coordinates, etc.). At this point, the document parsing module 102 sends the extracted “plain text+layout structure data” to the AI data analysis module 103.

Step S303: Receiving text and defining an expected structure to convert the text into the format required for structured data. In an instruction prompt, the text is combined with the expected structure and sent to the AI data analysis module 103 for processing. The AI data analysis module 103 packages the OCR-extracted text and layout information into an instruction prompt based on a target structure (e.g., JSON schema, field list, data dictionary) preset by the user or the system.

Step S304: Reorganizing and organizing the extracted text according to the predefined structure to establish structured data for subsequent analysis. The structured data is analyzed to identify and extract key features and provide valuable insights based on the extracted key features. The AI data analysis module 103 extracts field values, identifies field types, and converts unstructured text into structured data, such as a JSON schema, which is temporarily stored in a storage unit. Based on the plurality of sorted and structured data, the AI data analysis module 103 determines a data analysis type to be performed and generates preliminary data analysis opinions and a plurality of chart and document generation options. The preliminary data analysis opinions and the plurality of chart and document generation options are presented through the user interface 101 When a user selects one of the plurality of chart and document generation options via the user interface 101, the AI data analysis module 103 generates an analysis result based on the final structured data and analysis report text and then sends the analysis result to the document generation module 105 and the chart generation module 104. The document generation module 105 generates a final document (e.g., JSON file, CSV, readable PDF report, or templated Word/HTML) based on the structured data (e.g., JSON) provided by the AI data analysis module 103 and the user's instruction prompt and the analysis result. Subsequently, the generated text and tables are embedded into a report or output in a format specified by the user, and then returned to the user interface for download or preview. Similarly, the chart generation module 104 obtains the structured data output by the AI data analysis module 103 to generate a chart (bar chart, line graph, pie chart, table visualization, etc.) combined with the analysis result. The chart may be embedded into the report produced by the document generation module or directly returned to the user interface for interactive viewing.

Additionally, the AI data analysis module 103 can further generate a plurality of analysis options based on the analysis and present the analysis options in the dialogue history area 202 of the user interface 101. Afterward, the result is displayed on the user interface 101 for user operation. If the user requests analysis from the plurality of analysis options, the user interface 101 again sends new settings back to the corresponding modules (document parsing module 102/AI data analysis module 103/chart generation module 104/document generation module 105) to perform the workflow. For example, the AI data analysis module 103 will generate an analysis result again, and the chart generation module 104 will generate a second chart corresponding to the analysis result.

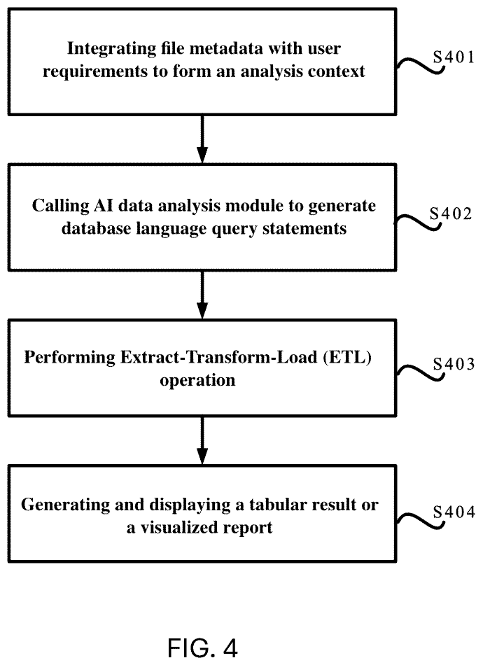

FIG. 4 is a flowchart illustrating the operation of the data analysis system automatically generating a database based on user requirements and file metadata and performing Extract-Transform-Load (ETL) operation according to a preferred embodiment of the present disclosure. Referring to FIG. 4, the steps of the flowchart include:

Step S401: Integrating file metadata with user requirements to form an analysis context. The user inputs query intent, analysis requirements, or field specifications through the user interface 101. The system simultaneously reads the file metadata (e.g., field names, data types, time intervals, file sources, etc.). The user interface 101 integrates the “user requirements and file metadata” into a complete contextual description and sends it to the AI data analysis module 103.

Step S402: Calling the AI data analysis module 103 to generate database language query statements. The AI data analysis module 103 converts the integrated context (including file structure and requirement descriptions) into an instruction prompt. The AI data analysis module 103 activates an internal Large Language Model (LLM) to generate a corresponding database query language, such as SQL, based on the descriptions.

Step S403: Performing Extract-Transform-Load (ETL) operation. The AI data analysis module 103 analyzes the structure of data sources and generates SQL including Extract-Transform-Load (ETL) steps (e.g., JOIN, aggregation, cleaning rules, etc.).

Upon receiving the generated SQL query, the AI data analysis module 103 performs Extract-Transform-Load (ETL) operation on specified data and the ETL operation includes: retrieving data from data sources (e.g., a plurality of tables or document transformation results); transforming the data, performing missing value imputation, duplicate removal, format correction, and field alignment based on SQL script; and loading the transformed and cleaned data into an internal structured storage for subsequent presentation.

Step S404: Generating and displaying a tabular result or a visualized report. If a report or record need to be generated during the transformation process, the data is sent to the document generation module 105. The document generation module 105 receives the data generated by the ETL operation and generates table format outputs (e.g., HTML, Excel, PDF, or embedded table formats). If necessary, a record document for the SQL query and execution summary can be also automatically generated. If the user requests a visualized display, interactive charts (e.g., data quality statistics, field distribution maps, etc.) can be generated based on the result generated by the ETL operation. If the user modifies requirements or provides new conditions, the process restarts from step S401.

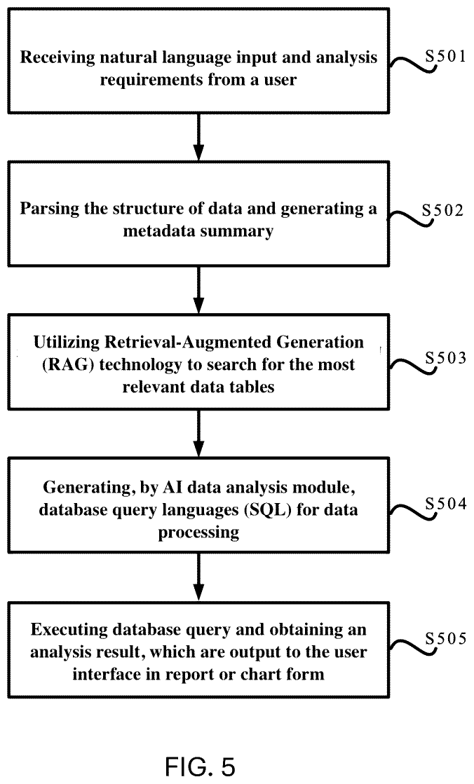

FIG. 5 is a flowchart illustrating the operation of the data analysis system combining metadata summaries and Retrieval-Augmented Generation (RAG) technology to automatically generate, execute, and analyze database language queries based on user requirements according to a preferred embodiment of the present disclosure. Referring to FIG. 5, the steps of the flowchart include steps S501~S505.

Step S501: Receiving natural language input and analysis requirements from a user. The user interface 101 receives natural language input and analysis requirements. The user uploads data files (e.g., CSV, database snapshots, reports, etc.) through the interface. The user inputs analysis goals in natural language (e.g., “Please analyze the sales trend for this month”). The system packages this requirement into a “user task description” and sends it to the AI data analysis module 103 along with file connection information.

Step S502: Parsing the structure of data and generating a metadata summary. The document parsing module 102 is configured to establish a metadata summary and parse the structure of the uploaded data, including: file structure (field names, types, row counts, table relationships), field summary, and statistical information (e.g., number of unique values, proportion of missing values (null)), to generate a “metadata summary” and provide the “metadata summary” to the AI data analysis module 103 as an analysis basis.

Step S503: Utilizing Retrieval-Augmented Generation (RAG) technology to search for the most relevant data tables. The AI data analysis module 103 utilizes RAG technology to search for tables or fields most relevant to the user's requirements from the database or uploaded datasets, calculates, based on the metadata summary, the correlation between each data table and the analysis goal, and finally selects the top N most useful tables as input for an SQL generation stage.

Step S504: The AI data analysis module 103 generates database query languages for data processing. The AI data analysis module 103 combines the user requirements, the structures of the selected tables, and metadata into an instruction prompt and sends the instruction prompt to an internal language model to generate a corresponding database query, such as SQL query.

Step S505: Executing database query and obtaining an analysis result, which are output to the user interface in report or chart form. The AI data analysis module 103 extracts the SQL query, connects to the data source for execution, and obtains an analysis result. The data of the analysis result is sent to the document generation module 105 or the chart generation module 104 according to requirements to generate visualized results (line graphs, bar charts, heat maps, etc.). Finally, the content of the visualized results is output and returned to the user interface 101 for user review.

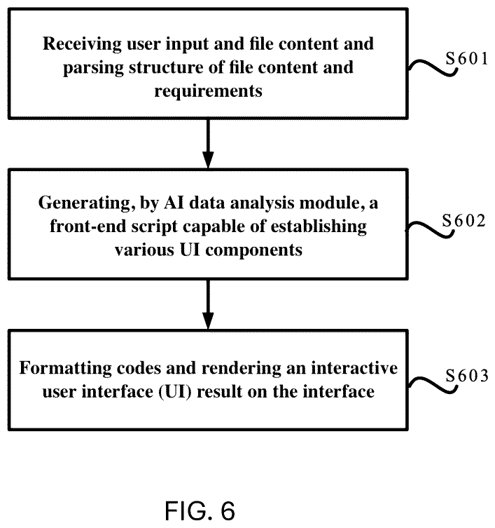

FIG. 6 is a flowchart illustrating the operation of the data analysis system automatically generating a front-end user interface (UI) based on user requirements according to a preferred embodiment of the present disclosure. Referring to FIG. 6, the steps of the flowchart include:

Step S601: Receiving user input and file content and parsing the structure of the file content and requirements. The user interface 101 allows a user to upload a file or input a description (e.g., “Create a form interface for me to upload data” or “Generate a chart configuration panel”). These inputs are passed to a back-end module for analysis and preprocessing. If the inputs include a file or data structure file (e.g., JSON, CSV, API Schema), the document parsing module 102 parses the structure and field information of the file to extract information helpful for interface generation (e.g., field types, mandatory fields, data options).

Step S602: The AI data analysis module 103 generates a front-end script capable of establishing various UI components. Upon receiving the processed input content, the AI data analysis module 103 organizes it into a structured description, converts it into an instruction prompt for the language model and provides the instruction prompt to the internal language model to analyze and generate front-end UI component scripts (e.g., HTML, React, Vue, or Tailwind CSS components).

Step S603: Formatting codes and rendering an interactive user interface (UI) result on the interface. The document generation module 105 receives the front-end scripts generated by the language model and performs format verification and packaging to ensure the codes can execute correctly. Depending on the UI source codes or report derived by user's selection, the document generation module 105 can package the UI result into HTML/JS/CSS component files or documented descriptions (e.g., JSON structure, API mapping table, component relationship diagram).

The document generation module 105 loads and executes the generated front-end script to dynamically establish UI components. The user can see interactive pages (e.g., forms, buttons, data visualization blocks, etc.) generated by the language model on the interface. If the user proposes modifications (e.g., adjusting styles or functions), the modifications can be sent back to the AI data analysis module 103 for regenerating the interactive pages from step S601.

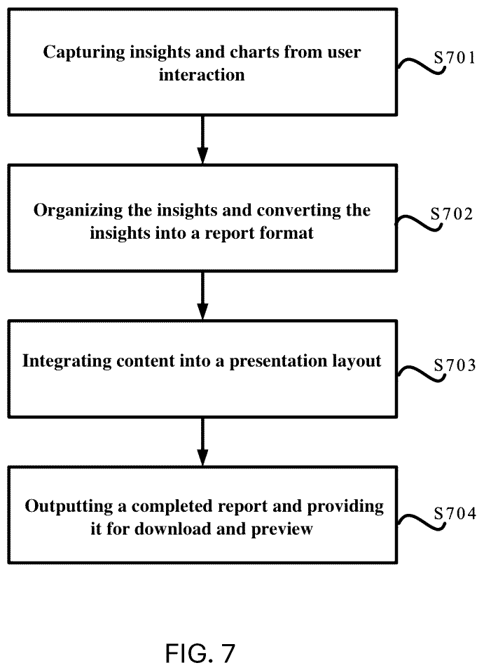

FIG. 7 is a flowchart illustrating the operation of the data analysis system automatically organizing, transforming, and generating a final report based on insights and charts generated during user interaction according to a preferred embodiment of the present disclosure. Referring to FIG. 7, the steps of the flowchart include:

Step S701: Capturing insights and charts from user interaction. During the dialogue or operation with the user, the system records the questions queried by the user, the chart selected by the user, and the analysis result focused by the user. The AI data analysis module 103 monitors the entire interaction process with the user and identifies key insights (e.g., trends, anomalies, performance indicator changes). These analysis summaries are automatically converted into readable text (insight sentences). The chart generation module 104 tags and stores visualized results (e.g., line graphs, pie charts, statistical tables) generated during the interaction for subsequent report use.

Step S702: Organizing the insights and converting the insights into a report format. The AI data analysis module 103 aggregates all insights and corresponding charts, automatically classifies the insights and corresponding charts (e.g., by topic, time, region, performance indicator group), and converts the insights and corresponding charts into a content structure suitable for report (e.g., “Summary→Analysis Highlights→Chart Description→Recommendations”) based on a report template or specification. The AI data analysis module 103 then transfers the data to the document generation module 105 for layout arrangement.

Step S703: Integrating content into a presentation layout. The document generation module 105 is configured to insert analysis text and charts based on a preset report template (PPT layout) and automatically configure titles, summaries, and chart positions for each section. The chart generation module 104 generates chart images or objects based on chart codes generated by the AI data analysis module 103 and embeds the charts into corresponding slide blocks.

Step S704: Outputting a completed report. A final report file (e.g., PowerPoint, PDF, HTML report, etc.) is exported to the user interface 101 to provide preview, download, or sharing options, allowing the user to review and store the final report.

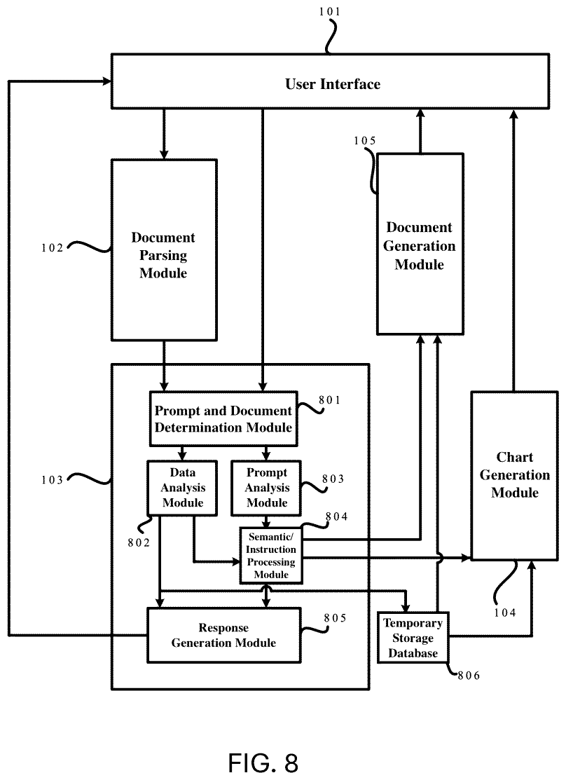

FIG. 8 is a detailed system block diagram of a data analysis system according to a preferred embodiment of the present disclosure. Referring to FIG. 8, in the present embodiment, the AI data analysis module 103 further includes a prompt and document determination module 801, a data analysis module 802, a prompt analysis module 803, a semantic and instruction processing module 804, and a response generation module 805. Additionally, the data analysis system further includes a temporary storage database 806.

The prompt and document determination module 801 is configured to determine whether the input content belongs to a prompt or an instruction (e.g., query command, analysis task, or formatting request) to determine how to proceed with the input content subsequently. The data analysis module 802 is configured to perform actual data analysis, model inference, data cleaning, and statistical operations. Furthermore, the text part in the document is also separated and handed over to the prompt analysis module 803. The prompt analysis module 803 is configured to decompose the user's requirements, prompts, and instructions in natural language into semantic fragments to generate LLM prompts or query logics. The semantic and instruction processing module 804 is configured to combine the results generated by the data analysis module 802 and the prompt analysis module 803 to determine user intents and generate specific tasks (e.g., SQL query, chart request, report generation instruction). The response generation module 805 is configured to generate a final response text or report content based on the task results (e.g., data analysis results or generated content) output by the semantic and instruction processing module 804. The temporary storage database 806 is configured to store intermediate data (e.g., user context, analysis results, chart cache, language model return values) generated during the process for subsequent module use. The temporary storage database 806 is configured to temporarily stores data, documents, and information analyzed by the AI data analysis module 103. When the document generation module 105 or the chart generation module 104 performs generation processes, the corresponding data can be retrieved from the temporary storage database 806.

Taking the process in FIG. 3 as an example, in this process, the data analysis system needs to first determine whether to perform OCR or structured analysis based on the text content input or uploaded by the user. In the present embodiment, when step S303 is being performed, the prompt and document determination module 801 makes a determination on whether the user instruction is a document processing type task; the semantic and instruction processing module 804 converts this determination into a instruction prompt, i.e., a prompt structure; the data analysis module 802 performs actual data analysis (e.g., data organization after OCR, field structure inference, classification, or prediction). In step S304, the response generation module 805 generates report output based on the analysis results and generates insights, such as generating a plurality of analysis options and explanatory text. The temporary storage database 806 temporarily stores the text structure and intermediate analysis results. Subsequently, the chart generation module 104 and the document generation module 105 can generate corresponding documents and/or charts based on the temporary text structure and intermediate analysis results stored in the temporary storage database 806 and the instruction prompts output by the semantic and instruction processing module 804.

Taking the query generation and the ETL operation of FIG. 4 as an example, in step S401, the integration of file metadata and user requirements forming an analysis context involves the prompt and document determination module 801 determining that the user input belongs to a query task, and step S402 involves the prompt analysis module 803 parsing query keywords (e.g., “average sales,” “recent three months,” “by region”) and generating a prompt structure. Step S403 involves the semantic and instruction processing module 804 generating SQL generation instructions and the data analysis module 802 executing SQL queries and ETL data processing. Afterward, these data are cleaned and then temporarily stored with the query result in the temporary storage database 806 for being used by the chart generation module 104 and the document generation module 105.

Taking the process of FIG. 5 as an example, in step S501, the prompt and document determination module 801 determines that this is a “query type” task; in step S502, the prompt and document determination module 801 and the data analysis module 802 transmit the extracted file text to the prompt analysis module 803 to extract semantic key points and generate retrieval keywords. In step S503, the data analysis module 802 performs RAG and data comparison. The semantic and instruction processing module 804 integrates the results to make the model generate database query languages (such as SQL) or analysis statements. These database query languages are executed, and the generated temporary analysis data and retrieval results are temporarily stored in the temporary storage database 806 for subsequent chart output.

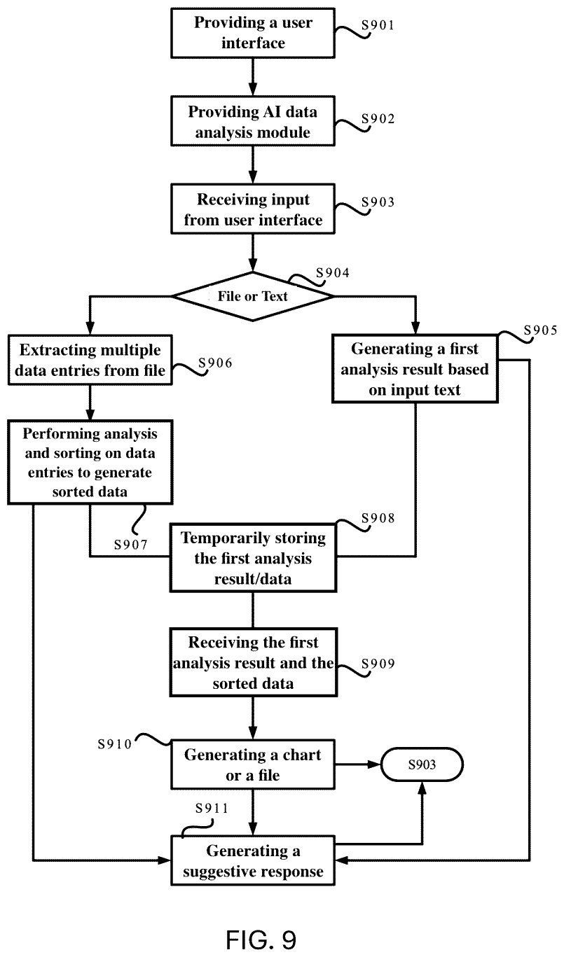

From the above embodiments, a data analysis method can be summarized. FIG. 9 illustrates a flowchart of the data analysis method according to a preferred embodiment of the present disclosure. Referring to FIG. 9, the data analysis method includes:

Step S901: Providing a user interface. The user interface is configured to input at least one text and upload at least one file.

Step S902: Providing an AI data analysis module. The AI data analysis module is configured to receive the at least one text from the user interface and generate an analysis result based on the at least one text. In addition, the AI data analysis module is further configured to receive a plurality of data entries from the user interface and perform analysis and sorting on the plurality of data entries to generate a plurality of sorted data.

Step S903: Receiving input from the user interface.

Step S904: Determining whether the input from the user interface is a file or text. If the input from the user interface is text, enter step S905. If the input from the user interface is a file, enter step S906.

Step S905: Generating a first analysis result based on the input text. Afterward, execute step S908 and return to step S903 to continue receiving user input. If attempts fail more than a certain number of times and reach a threshold value, proceed to step S911.

Step S906: Extracting a plurality of data entries from the at least one file uploaded by the user.

Step S907: Performing analysis and sorting on the plurality of data entries to generate a plurality of sorted data. Afterward, execute step S908 and return to step S903 to continue receiving user input. If attempts fail more than a certain number of times and reach a threshold value, proceed to step S911.

Step S908: Temporarily storing the first analysis result and data.

Step S909: Receiving the first analysis result from the AI data analysis module and receiving the plurality of sorted data from the storage unit.

Step S910: Generating a chart or a file based on the first analysis result and the plurality of sorted data. In the present embodiment, the AI data analysis module generates a chart code for the chart generation module, and the chart generation module generates a data analysis chart based on the chart code. When the chart or the file is generated successfully, the user interface is updated with a result or a download link outputted and with further analysis options provided, and it returns to step S903 to continue receiving user input. If attempts fail, it first returns to step S908 to restart step S909 and step S910 using the data to continue the attempt. If attempts exceed a certain number of times and reach a threshold value, proceed to step S911. In addition, if it is found in this step that the data in step S908 or step S909 is incorrect or inconsistent with requirements (for example, the temporarily stored data belongs to the year 2023 but the requirement is for the year 2025), then proceed to step S911.

Step S911: Generating a suggestive response. In the above embodiments, an execution threshold value is set upon an occurrence of any of the following situations during the execution of steps S905, S906, S907, S909, and S910, as follows: extracting data from a file fails in step S906; the plurality of data entries received in step S907 are defective; the text input in step S905 is unexecutable; or the temporarily stored data in steps S909 and S910 is insufficient to generate a chart according to instructions. For example, if execution is repeated twice and both times fail, the AI data analysis module generates a generation failure response and presents it on the user interface, informing the user of missing data and generating a suggestive response to update the user interface, and presenting the suggestive response on the user interface and returning to step S903. Similarly, if extra intent is found in the input language of the analysis result generated in step S905, it also enters step S911 to generate a suggestive response, providing limited options on the user interface and returning to step S903 to make the user continue inputting data.

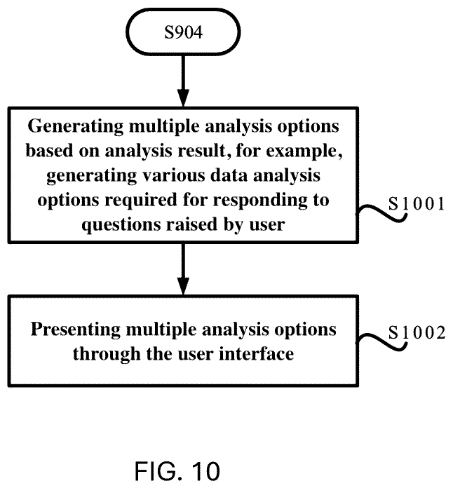

FIG. 10 is a flowchart of sub-steps of step S905 and step S903 of the data analysis method according to a preferred embodiment of the present disclosure. Referring to FIG. 10, the sub-steps of step S905 include:

Step S1001: Generating a plurality of analysis options based on the first analysis result. For example, various data analysis options required for responding to questions raised by the user are generated. Afterward, return to sub-step S1002 of step S903.

Step S1002: Presenting a plurality of analysis options through the user interface. This step allows users to have limited options and decide what data analysis to perform.

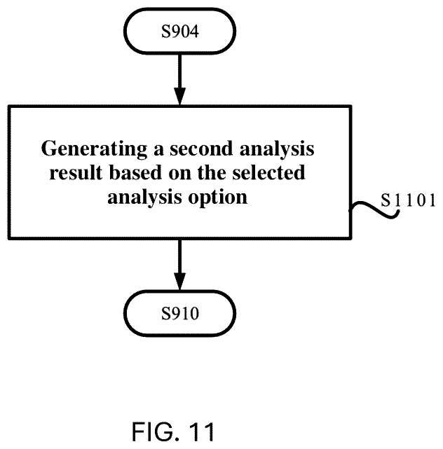

FIG. 11 is a flowchart of sub-steps of step S905 of the data analysis method according to a preferred embodiment of the present disclosure. Referring to FIG. 11, the sub-steps of step S905 include:

Step S1101: Generating a second analysis result based on the selected analysis option. Afterward, execute step S910 to generate a second chart based on the second analysis result.

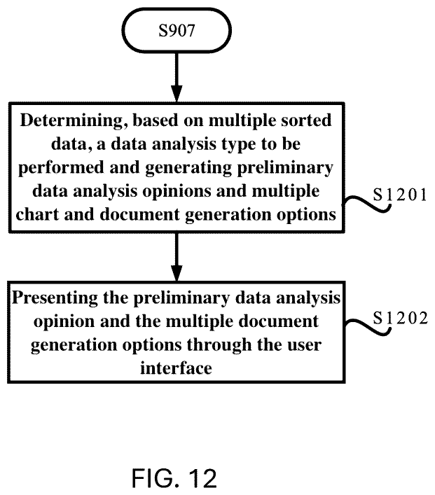

FIG. 12 is a flowchart of sub-steps between step S907 and step S903 of the data analysis method according to a preferred embodiment of the present disclosure. Referring to FIG. 12, additional sub-steps after step S907 include:

Step S1201: Determining, based on the plurality of sorted data, a data analysis type to be performed and generating preliminary data analysis opinions and a plurality of chart and document generation options.

Sub-steps of step S903 include:

Step S1202: Presenting the preliminary data analysis opinion and the plurality of document generation options through the user interface. This step allows the user to obtain the preliminary data analysis opinion and the document generation options and determine what document to generate.

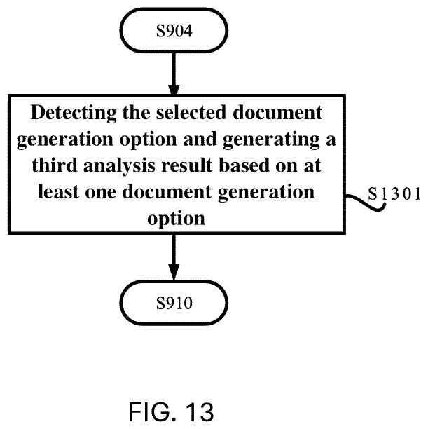

FIG. 13 is a flowchart of sub-steps of step S905 of the data analysis method according to a preferred embodiment of the present disclosure. Referring to FIG. 13, the sub-steps of step S905 include:

Step S1301: Detecting the selected document generation option and generating a third analysis result based on at least one document generation option. Afterward, execute step S910 to generate a specific format document file based on the analysis result. In the present embodiment, the AI data analysis module can also collaborate with the document generation module and the chart generation module to make the specific format document file include data an analysis chart. The specific format document files include, for example, Word, Excel, PowerPoint, PDF, etc. The present disclosure is not limited thereto.

In summary, the preferred embodiments of the present disclosure employ a data analysis system integrating a user interface, a document parsing module, an AI data analysis module, a chart generation module, and a document generation module, such that the data analysis system can execute the data analysis method and complete the entire workflow from data input and intelligent analysis to chart and document output with high efficiency and accuracy. The AI data analysis module of the preferred embodiment of the present disclosure specifically adopts the “Plan-Do-Check-Act” logic cycle as the analysis core, enabling it to automatically plan analysis steps and methods (Plan) upon receiving data, execute data processing and intelligent computation (Do), then compare and verify based on the analysis results (Check), and continuously correct and optimize the analysis model based on the verification results (Act), so that the overall analysis process possesses self-correction capabilities and achieves the effect of continuous refinement.

The data analysis system first allows a user to input text commands and upload a file via the user interface. The document parsing module automatically extracts multiple data entries from the file, reducing manual processing time and errors. Subsequently, the AI data analysis module performs dynamic analysis and data sorting based on the “Plan-Do-Check-Act” logic to generate preliminary analysis results and diverse analysis options. Users can make interactive selections based on their needs to obtain more precise analysis results. Simultaneously, the data analysis system can automatically determine suitable data analysis types, providing preliminary analysis opinions and multiple chart or document generation options, making the data visualization process more flexible and professional. The chart generation module can automatically generate a corresponding chart based on the analysis results and facilitate rapid reproduction through chart code. The document generation module can automatically produce documents in specific formats containing charts and analysis reports based on selections, enhancing report production efficiency and consistency and allowing general users to quickly complete professional-grade data analysis and report generation.

The specific embodiments proposed in the detailed description of the preferred embodiments are merely intended to facilitate the explanation of the technical content of the present disclosure, rather than to narrowly limit the present disclosure to the above-mentioned embodiments. Various changes and implementations made without departing from the spirit of the present disclosure and the scope of the following claims shall fall within the scope of the present disclosure. Therefore, the scope of protection of the present disclosure shall be defined by the appended claims.

1. A data analysis system, comprising:
a user interface configured to input at least one text and upload at least one file;
a document parsing module coupled to the user interface and configured to receive the at least one file and extract a plurality of data entries from the at least one file;
an artificial intelligence (AI) data analysis module coupled to the user interface and the document parsing module and configured to:
receive the at least one text from the user interface;
generate a first analysis result based on the at least one text;
receive the plurality of data entries from the document parsing module;
analyze and sort the plurality of data entries to generate a plurality of sorted data; and
store the plurality of sorted data in a storage unit;
a chart generation module coupled to the AI data analysis module and the storage unit and configured to:
receive the first analysis result from the AI data analysis module and receive the plurality of sorted data from the storage unit; and
generate a first chart based on the first analysis result and the plurality of sorted data.

2. The data analysis system of claim 1, wherein:
the AI data analysis module is further configured to generate a plurality of analysis options based on the first analysis result; and
the user interface is further configured to present the plurality of analysis options.

3. The data analysis system of claim 2, wherein:
the plurality of analysis options at least comprise a first analysis option and a second analysis option; and
the AI data analysis module is further configured to detect whether at least one of the first analysis option and the second analysis option is selected and generate a second analysis result based on the at least one selected analysis option; and
the chart generation module is further configured to generate a second chart based on the second analysis result.

4. The data analysis system of claim 1, wherein:
the AI data analysis module is further configured to determine, based on the plurality of sorted data, a data analysis type to be performed and generate a preliminary data analysis opinion and a plurality of chart and document generation options; and
the user interface is further configured to present the preliminary data analysis opinion and the plurality of chart and document generation options.

5. The data analysis system of claim 4, further comprising:
a document generation module coupled to the AI data analysis module and configured to generate a specific format document file, wherein:
the plurality of chart and document generation options at least comprises a first chart and document generation option and a second chart and document generation option; and
the AI data analysis module is further configured to detect whether at least one of the first chart and document generation option and the second chart and document generation option is selected and generate a third analysis result based on the at least one selected chart and document generation option; and
the document generation module is further configured to generate the specific format document file based on the third analysis result.

6. The data analysis system of claim 5, wherein:
the specific format document file comprises at least one data analysis chart.

7. The data analysis system of claim 1, wherein:
the first analysis result comprises a chart code; and
the chart generation module is further configured to generate a data analysis chart based on the chart code.

8. A data analysis method, comprising:
providing a user interface configured to input at least one text and upload at least one file;
extracting a plurality of data entries from the at least one file;
providing an artificial intelligence (AI) data analysis module configured to:
receive the at least one text from the user interface;
generate a first analysis result based on the at least one text;
receive the plurality of data entries;
analyze and sort the plurality of data entries to generate a plurality of sorted data; and
receive the first analysis result from the AI data analysis module and receive the plurality of sorted data from the storage unit; and
generating a first chart based on the first analysis result and the plurality of sorted data.

9. The data analysis method of claim 8, wherein:
the AI data analysis module is further configured to:
generate a plurality of analysis options based on the first analysis result; and
present the plurality of analysis options on the user interface.

10. The data analysis method of claim 9, wherein:
the plurality of analysis options at least comprise a first analysis option and a second analysis option; and
the method further comprises:
detecting, by the AI data analysis module, whether at least one of the first analysis option and the second analysis option is selected and generating a second analysis result based on the at least one selected analysis option; and
generating a second chart based on the second analysis result.

11. The data analysis method of claim 8, further comprising:
determining, by the AI data analysis module, a data analysis type to be performed based on the plurality of sorted data and generating a preliminary data analysis opinion and a plurality of chart or document generation options; and
presenting the preliminary data analysis opinion and the plurality of chart and document generation options on the user interface.

12. The data analysis method of claim 11, wherein:
the plurality of chart and document generation options at least comprises a first chart and document generation option and a second chart and document generation option; and
the method further comprising:
detecting, by the AI data analysis module, whether at least one of the first chart and document generation option and the second chart and document generation option is selected and generating a third analysis result based on the at least one selected chart and document generation option; and
generating a specific format document file based on the third analysis result.

13. The data analysis method of claim 12, wherein:
the specific format document file comprises at least one data analysis chart.

14. The data analysis method of claim 8, wherein the first analysis result comprises a chart code, and the method further comprises:
generating a data analysis chart based on the chart code.

15. A data analysis apparatus, comprising a processor and a storage unit storing a plurality of instructions which, upon execution by the processor, cause the apparatus to perform a method as claimed in claim 7.
